(19) United States
(12) Patent Application Publication
(10) Pub. No.: US 2017/0228548 A1
(43) Pub. Date: Aug. 10, 2017

(54) ENCRYPTED CODE EXECUTION

(71) Applicant: INTEL CORPORATION, Santa Clara, CA (US)

(72) Inventor: Yevgeny Rouban, Novosibirsk (RU)

(21) Appl. No.: 15/501,704

(22) PCT Filed: Aug. 20, 2014
(86) PCT No.: PCT/IB2014/002121

§ 371 Date: Feb. 3, 2017

(51) Int. Cl. G06F 21/60; H04L 9/32; H04L 9/30

(52) U.S. Cl. CPC G06F 21/602; H04L 9/30; H04L 9/3247

(57) ABSTRACT

Embodiments of an invention for encrypted code execution are disclosed. In one embodiment, a processor includes a private key, a code decryptor, and an encryption unit. The code decryptor is to decrypt the encrypted code to generate decrypted code, the encrypted code encrypted with a public key corresponding to the private key. The execution unit is to execute the decrypted code.

### BACKGROUND

1. Field

The present disclosure pertains to the field of information processing, and more specifically, to the distribution and use of software in information processing systems.

2. Description of Related Art

Software developers and distributors have used various approaches to attempt to control the use of their executable code in order to protect their intellectual property and potential revenue. Such approaches include activation codes, license servers, metering, copy protection, and hardware dongles.

### BRIEF DESCRIPTION OF THE FIGURES

The present invention is illustrated by way of example and not limitation in the accompanying figures.

FIG. 1 illustrates a system including support for encrypted code execution according to an embodiment of the present invention.

FIG. 2 illustrates a processor including support for encrypted code execution according to an embodiment of the present invention.

FIG. 3 illustrates a system architecture including encrypted code execution according to an embodiment of the present invention.

FIG. 4 illustrates a method for encrypted code execution according to embodiments of the present invention.

### DETAILED DESCRIPTION

Embodiments of an invention for encrypted code execution are described. In this description, numerous specific details, such as component and system configurations, may be set forth in order to provide a more thorough understanding of the present invention. It will be appreciated, however, by one skilled in the art, that the invention may be practiced without such specific details. Additionally, some well-known structures, circuits, and other features have not been shown in detail, to avoid unnecessarily obscuring the present invention.

In the following description, references to “one embodiment,” “an embodiment,” “example embodiment,” “various embodiments,” etc., indicate that the embodiment(s) of the invention so described may include particular features, structures, or characteristics, but more than one embodiment may and not every embodiment necessarily does include the particular features, structures, or characteristics. Further, some embodiments may have some, all, or none of the features described for other embodiments.

As used in this description and the claims, and unless otherwise specified, the use of the ordinal adjectives “first,” “second,” “third,” etc. to describe an element merely indicate that a particular instance of an element or different instances of like elements are being referred to, and is not intended to imply that the elements so described must be in a particular sequence, either temporally, spatially, in ranking, or in any other manner.

As described in the background section, software developers and distributors have used various approaches to attempt to control the use of their executable code in order to protect their intellectual property and potential revenue. Approaches using embodiments of the present invention may be desired to reduce susceptibility to reverse engineering and unauthorized use.

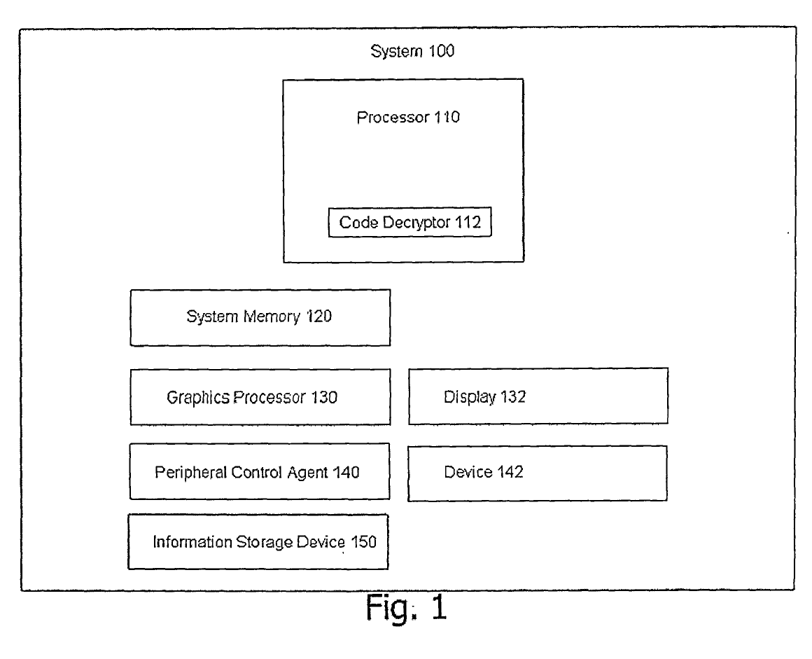

FIG. 1 illustrates system 100, an information processing system including support for encrypted code execution according to an embodiment of the present invention. System 100 may represent any type of information processing system, such as a server, a desktop computer, a portable computer, a set-top box, a hand-held device such as a tablet or a smart phone, or an embedded control system. System 100 includes processor 110, system memory 120, graphics processor 130, peripheral control agent 140, and information storage device 150. Systems embodying the present invention may include any number of each of these components and any other components or other elements, such as peripherals and input/output devices. Any or all of the components or other elements in this or any system embodiment may be connected, coupled, or otherwise in communication with each other through any number of buses, point-to-point, or other wired or wireless interfaces or connections, unless specified otherwise. Any components or other portions of system 100, whether shown in FIG. 1 or not shown in FIG. 1, may be integrated or otherwise included on or in a single chip (a system-on-a-chip or SOC), die, substrate, or package.

System memory 120 may be dynamic random access memory or any other type of medium readable by processor 110. Graphics processor 130 may include any processor or other component for processing graphics data for display 132. Peripheral control agent 140 may represent any component, such as a chipset component, including or through which peripheral, input/output (I/O), or other components or devices, such as device 142 (e.g., a touchscreen, keyboard, microphone, speaker, other audio device, camera, video or other media device, network adapter, motion or other sensor, receiver for global positioning or other information, etc.) and/or information storage device 150, may be connected or coupled to processor 110. Information storage device 150 may include any type of persistent or non-volatile memory or storage, such as a flash memory and/or a solid state, magnetic, or optical disk drive. Note that graphics processor 130, peripheral control agent 140, and any other component or agent capable of executing instructions (and/or according to a program or a pattern or a set of rules), or may contain an embodiment of the present invention, in addition to or instead of processor 110.

Processor 110 may represent one or more processors or processor cores integrated on a single substrate or packaged within a single package, each of which may include multiple threads and/or multiple execution cores, in any combination. Each processor represented as or in processor 110 may be any type of processor, including a general purpose microprocessor, such as a processor in the Intel® Core™ Processor Family or other processor family from Intel® Corporation or another company, or a special purpose processor or microcontroller. Processor 110 may be architected and designed to operate according to any instruction set architecture, with or without being controlled by microcode. Furthermore, processor 110 may represent any device or component in an information processing system in which an embodiment of the present invention may be implemented.

Support for encrypted code execution according to an embodiment of the present invention may be implemented in a processor, such as processor 110, using any combination of circuitry and/or logic embedded in hardware, microcode, firmware, and/or other structures arranged as described below or according to any other approach, and is represented in FIG. 1 as code decryptor 112.

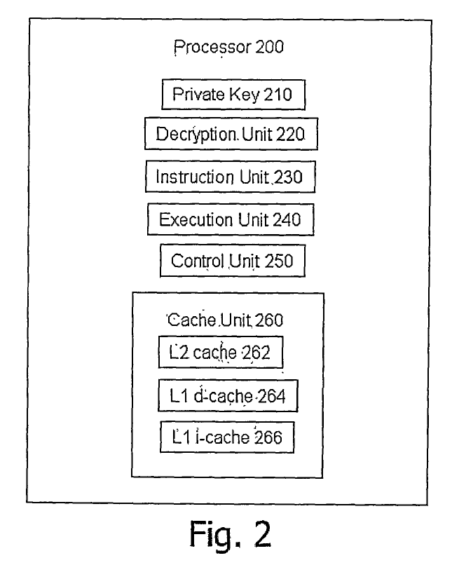

FIG. 2 illustrates processor 200, an embodiment of which may serve as processor 110 in system 100. Processor 200 includes private key 210, decryption unit 220, instruction unit 230, execution unit 240, control unit 250, and cache unit 260. Processor 200 may also include any other circuitry, structures, or logic not shown in FIG. 2. The functionality of code decryptor 112, as introduced above and further described below, may be contained in or distributed among any of the labeled units or elsewhere in processor 200. Furthermore, the functionality and or circuitry of each of the described and/or illustrated units of processor 200 may be combined and/or distributed in any manner.

Private key 210 may represent any hardware key, key set, or other value(s) embedded into processor 200 that may be used as a key in a cryptographic algorithm. The size of private key 210 may be any number of bits (e.g., 32, 256, etc.). In an embodiment, the value of private key 210 may be embedded, programmed, or otherwise stored in a read-only memory during or after manufacturing of processor 200, for example, using conductive tie-ups or tie-downs or fuses. Private key 210 may be unique per processor core, processor IC, processor package, or information processing system.

In an embodiment, private key 210 (e.g., the read-only memory in which it is stored) is inaccessible to software or firmware running on processor 200 or any other processor or other agent in system 100, in other words, private key 210 is protected from being read by software or firmware. In an embodiment, private key 210 may be physically within or hardwired to decryption unit 220 such that only the hardware in decryption unit 220 has access to private key 210, and/or more specifically, is only available, readable, or otherwise accessible as needed for the decryption of encrypted instructions. Neither the value of the key nor the decryption operation is observable by any software or any other hardware. In other embodiments, private key 210 may also be used for other purposes.

Decryption unit 220 may include any circuitry, structures, and/or other hardware to execute one or more cryptographic algorithms for encrypting and/or decrypting information according to any known technique. For example, encryption unit 220 may use private key 210 to transform encrypted information (ciphertext) into unencrypted information (plaintext). In an embodiment, decryption unit 220 is to decrypt encrypted code to generate unencrypted code, such that the unencrypted code may be executed by one or more execution units in processor 200, such as execution unit 240.

Instruction unit 230 may include any circuitry, structures, and/or other hardware, such as an instruction decoder, to fetch, receive, decode, interpret, schedule and/or otherwise handle instructions to be executed by processor 200. Any instruction format may be used within the scope of the present invention; for example, an instruction may include an opcode and one or more operands, where the opcode may be decoded into one or more micro-instructions or micro-operations for execution by execution unit 240. Operands or other parameters may be associated with an instruction implicitly, directly, indirectly, or according to any other approach.

Execution unit 240 may include any circuitry, structures, and/or other hardware, such as an arithmetic unit, logic unit, floating point unit, shifter, etc., for processing data and executing instructions, micro-instructions, and/or micro-operations. Execution unit 240 may represent any one or more physically or logically distinct execution units.

Control unit 250 may include any circuitry, logic, or other structures, including microcode, state machine logic, and programmable logic, to control the operation of the units and other elements of processor 200 and the transfer of data within, into, and out of processor 200. Control unit 250 may cause processor 200 to perform or participate in the performance of method embodiments of the present invention, such as the method embodiments described below, for example, by causing processor 200, using execution unit 240, encryption unit 220, and/or any other resources, to execute instructions received by instruction unit 230 and micro-instructions or micro-operations derived from instructions received by instruction unit 230.

Cache unit 260 may include any one or more dedicated or shared cache memories in any levels of a memory hierarchy of system 100, implemented in static random access memory or any other memory technology, along with circuitry, structures, and/or other hardware to control and/or provide for their use and maintenance. In an embodiment, cache unit 260 may include level 2 (L2) cache 262, level 1 data cache (L1 d-cache) 264, and level 1 instruction cache (L1 i-cache) 266.

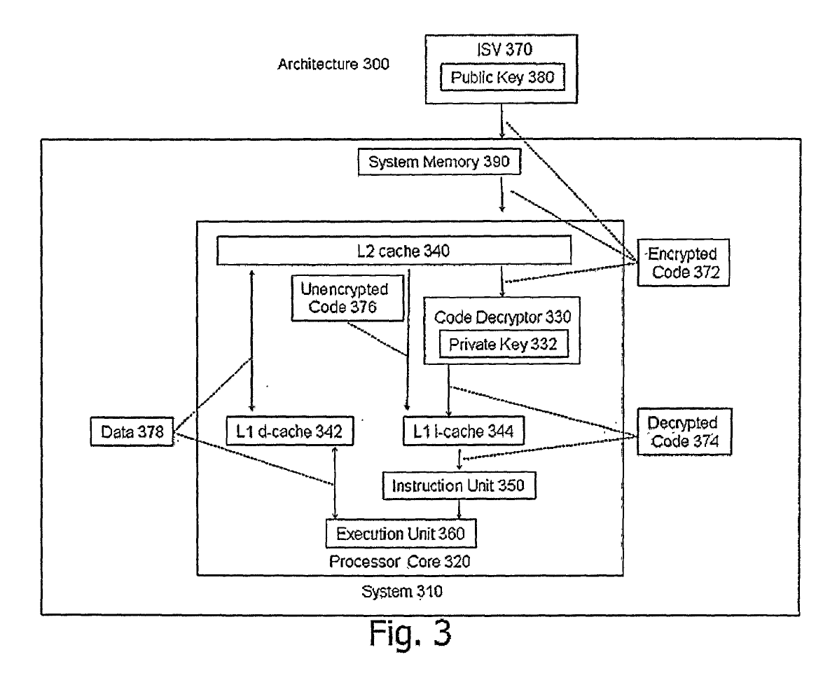

FIG. 3 illustrates architecture 300 for encrypted code execution according to an embodiment of the present invention. Architecture 300 includes system 310 and independent software vendor (ISV) 370. System 310 may represent an information processing system such as system 100, including processor core 320 and system memory 390, corresponding to a processor and system memory of system 100 as described above. Processor core 320 may represent a processor or processor core according to an embodiment of the present invention, such as processor 200, including code decryptor 330, as well as private key 332, L2 cache 340, L1 d-cache 342, L1 i-cache 344, instruction unit 350, and execution unit 360, each corresponding to a key, cache, or unit of processor 200 as described above.

Code decryptor 330 may represent a code decryptor according to an embodiment of the present invention, such as code decryptor 112 and/or decryption unit 220. ISV 370 may represent any software developer or distributor, content or service provider, or any other entity that may provide software, program, procedure, function, routine, module, or other group of code or instructions (collectively, code) to be installed on, run on, or executed by system 310. Such code may be encrypted by ISV 370, as described below, and is represented as encrypted code 372. Encrypted code 372 may be decrypted by code decryptor 330 according to an embodiment of the present invention to generate decrypted code 374. FIG. 3 also shows unencrypted code 376, which may represent any code from ISV 370 or any other source that has not been encrypted according to an embodiment of the present invention.

Encrypted code 372 may be encrypted by ISV 370 or any other entity such that it may be decrypted using private key 332. In an embodiment, private key 332 may be a private key of an asymmetric cryptography key pair, where public key 380 may be the other key of the pair. As such, public key 380 may be generated and/or signed with a verifiable digital signature by the manufacturer of processor core 320, in order to provide assurance to ISV 370 or another entity that code encrypted with public key 380 may be only executed (i.e., not altered, copied, reverse engineered, debugged, analyzed, etc.) by processor core 320 only (i.e., by no other processor core, except, if desired, one or more other processor cores with which private key 332 has been shared by the processor core manufacturer, or by or with a system vendor in an embodiment in which private key 332 is programmable by a system vendor). Public key 380 may be published and/or distributed as desired to allow its use by ISV 370 and other entities to encrypt their code.

Note that in the embodiment of FIG. 3, decrypted code 374 is routed to directly from L1 i-cache 344 to instruction unit 350 for execution by execution unit 360, and there is no path back to L2 cache 340 (as there may be for data 378) and no path through which decrypted code may be leaked. In other words, processor 320 includes only one path for the decrypted code, which is the path from code decryptor 332 to execution unit 360, which is the only destination of the decrypted code. In this embodiment, the path includes L1 i-cache 344 and instruction unit 350. Other embodiments may include other approaches to ensuring that code decrypted according to an embodiment may only be executed and may not be leaked to another cache, buffer, memory, or other storage location; for example, routing decrypted code directly to an execution unit if no instruction decode is necessary.

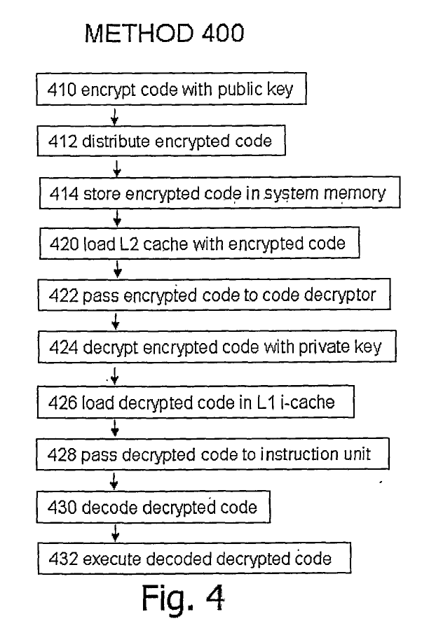

FIG. 4 illustrates method 400 for encrypted code execution according to embodiments of the present invention. Although method embodiments of the invention are not limited in this respect, reference may be made to elements of FIGS. 1, 2, and 3 in the descriptions of the method embodiment of FIG. 4. Various portions of method 400 may be performed independently by or with a combination of hardware (e.g., instruction unit 230, control unit 250, execution unit 240, and/or decryption unit 220), firmware, software, a user of an information processing system, etc.

In box 410 of method 400, code is encrypted, for example by an ISV with a public key provided by a processor manufacturer or vendor. In box 412, the encrypted code is provided to a user of an information processing system including a processor (e.g., processor 320) having a private key (e.g., private key 332). In box 414, the encrypted code is stored in a system memory (e.g., system memory 390) of the information processing system.

In box 420, one or more encrypted instructions from the encrypted code are loaded into a first storage structure (e.g., L2 cache 340) accessible to the processor. In box 422, the encrypted instruction(s) pass to a code decryptor (e.g., code decryptor 330). In box 424, the code decryptor uses the private key to decrypt the encrypted instruction(s). In box 426, the decrypted instruction(s) are loaded into a second storage structure (e.g., L1 i-cache 344) in the processor. In box 428, the decrypted instruction(s) pass to an instruction unit in the processor (e.g., instruction unit 230).

In box 430, the decrypted instruction(s) may be decoded or otherwise prepared the instruction unit for execution. In box 432, the decoded decrypted instruction is executed by an execution unit in the processor (e.g., execution unit 240). Note that throughout method 400, the decrypted instruction is unavailable for any purpose except execution by the processor.

In various embodiments of the present invention, the method illustrated in FIG. 4 may be performed in a different order, with illustrated boxes combined or omitted, with additional boxes, or with a combination of reordered, combined, omitted, or additional boxes. Furthermore, method embodiments of the present invention are not limited to method 400 or variations thereof. Many other method embodiments (as well as apparatus, system, and other embodiments) not described herein are possible within the scope of the present invention.

Embodiments or portions of embodiments of the present invention, as described above, may be stored on any form of a machine-readable medium. For example, software or firmware instructions stored on a medium readable by processor 200, which when executed by processor 200 may cause processor 200 to execute an embodiment of the present invention. Also, aspects of the present invention may be embodied in data stored on a machine-readable medium, where the data represents a design or other information usable to fabricate all or part of processor 200.

Thus, embodiments of an invention for encrypted code execution have been described. While certain embodiments have been described, and shown in the accompanying drawings, it is to be understood that such embodiments are merely illustrative and not restrictive of the broad invention, and that this invention not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

1. A processor comprising:
a private key;
a code decryptor to decrypt encrypted code to generate decrypted code, the encrypted code encrypted with a public key corresponding to the private key; and
an execution unit to execute the decrypted code.

2. The processor of claim 1, wherein the execution unit is the only destination of the decrypted code.

3. The processor of claim 1, further comprising a path from the code decryptor to the execution unit.

4. The processor of claim 3, wherein the path from the code decryptor to the execution unit is the only path for the decrypted code.

5. The processor of claim 4, further comprising an instruction unit in the path from the code decryptor to the execution unit.

6. The processor of claim 4, further comprising an instruction cache in the path from the code decryptor to the execution unit.

7. The processor of claim 6, wherein the instruction cache is a level one cache.

8. The processor of claim 7, further comprising a level two cache from which the encrypted code is to pass to the code decryptor.

9. A method comprising:
receiving, by a processor, encrypted code;
decrypting, using a private key within the processor, the encrypted code to generate decrypted code; and
executing, by the processor, the encrypted code.

10. The method of claim 9, wherein the encrypted code has been encrypted with a public key of an asymmetric cryptography key pair including the private key.

11. The method of claim 9, wherein the executing is performed by an execution unit, wherein the execution unit is the only destination of the encrypted code.

12. The method of claim 11, wherein the decrypting is performed by a code decryptor, wherein the private key is accessible only to the code decryptor.

13. The method of claim 12, wherein a path from the code decryptor to the execution unit is the only path for the decrypted code.

14. The method of claim 13, further comprising passing the decrypted code from the code decryptor to a level one instruction cache.

15. The method of claim 14, further comprising passing the decrypted code from the level one instruction cache to an instruction unit.

16. The method of claim 15, further comprising decoding, by the instruction unit, the decrypted instruction to generate a decoded decrypted instruction for execution by the execution unit.

17. The method of claim 16, further comprising loading the encrypted code into a level two cache.

18. The method of claim 17, further comprising passing the encrypted code from the level two cache to the code decryptor.

19. The method of claim 10, wherein the public key has been digitally signed by the manufacturer of the processor.

20. A system comprising:
a system memory to store encrypted code; and
a processor including
a private key;
a code decryptor to decrypt the encrypted code to generate decrypted code, the encrypted code encrypted with a public key corresponding to the private key; and
an execution unit to execute the decrypted code.
